(19) United States
(12) Patent Application Publication
(10) Pub. No.: US 2025/0036077 A1
(43) Pub. Date: Jan. 30, 2025

(54) HOLOGRAM MANUFACTURING DEVICE AND HOLOGRAM MANUFACTURING METHOD

(71) Applicant: Panasonic Intellectual Property Management Co., Ltd., Osaka (JP)

(72) Inventors: YOSUKE ARAKI, Osaka (JP); ATSUSHI FUKUI, Osaka (JP); WAHEI AGEMIZU, Osaka (JP); KAZUMASA TAKATA, Osaka (JP); KENICHIRO MASE, Osaka (JP)

(21) Appl. No.: 18/912,677

(22) Filed: Oct. 11, 2024

Related U.S. Application Data
(63) Continuation of application No. PCT/JP2023/011226, filed on Mar. 22, 2023.

(30) Foreign Application Priority Data
Apr. 27, 2022 (JP) 2022-073140
Aug. 26, 2022 (JP) 2022-135278
Aug. 26, 2022 (JP) 2022-135285

(51) Int. Cl. G03H 1/02; G03H 1/20

(52) U.S. Cl. CPC G03H 1/0276; G03H 1/0248; G03H 1/202; G03H 2001/0296; G03H 2222/12; G03H 2222/34; G03H 2223/18; G03H 2223/23; G03H 2223/24; G03H 2260/12

(57) ABSTRACT

A hologram manufacturing device includes a master hologram on which a diffraction grating is formed, a duplicate hologram disposed close to the master hologram, a first light source that emits, to the master hologram and the duplicate hologram, a first laser light that satisfies a Bragg diffraction condition in the diffraction grating, a second light source that emits, to the master hologram and the duplicate hologram, a second laser light that does not satisfy the Bragg diffraction condition in the diffraction grating, and a sensor that measures the second laser light. The hologram manufacturing device ends exposure of the duplicate hologram with the first laser light based on a measurement result of the sensor.

### TECHNICAL FIELD

The present disclosure relates to a hologram manufacturing device and a hologram manufacturing method.

### BACKGROUND ART

A device for manufacturing a duplicate hologram using a master hologram has conventionally known. In PTL 1, diffracted light is generated by causing laser light to enter a master hologram, and a hologram photosensitive material (photopolymer) of a duplicate hologram is exposed by the diffracted light. A duplicate hologram can be thus manufactured.

### CITATION LIST

### Patent Literature

PTL 1: Unexamined Japanese Patent Publication No. 2000-321962

### SUMMARY OF THE INVENTION

In general, production of a duplicate hologram has been performed by managing an exposure time of a photopolymer, that is, by managing the refractive index change amount of a photopolymer based on a light irradiation time for the photopolymer. The refractive index change amount of the photopolymer is mainly determined by an integrated exposure amount that is a product of the light intensity of a light source and the irradiation time, but is also affected by temperature, lot variation in sensitivity of the refractive index change of the photopolymer itself, and the like.

In addition, to produce a duplicate hologram, first-order diffracted light for the duplicate hologram is required. However, an error occurs in the first-order diffracted light with a photopolymer having a thickness different from the design value even though the refractive index change amount of the photopolymer is equal to the design value. Since the photopolymer is a transparent material, it is very difficult to measure the thickness of the photopolymer particularly when the photopolymer is sandwiched between transparent substrates.

For this reason, when the exposure time of the photopolymer is managed only by the light irradiation time for the photopolymer, the photopolymer itself of the duplicate hologram or the first-order diffracted light for the duplicate hologram may be different from the design value. Thus, the accuracy of the duplicate hologram may decrease.

An object of the present disclosure is to provide a device and a method for manufacturing a hologram with improved accuracy of a duplicate hologram.

To achieve the above-described object, a hologram manufacturing device according to one exemplary embodiment includes a master hologram on which a diffraction grating is formed, a duplicate hologram disposed close to the master hologram, a first light source that emits, to the master hologram and the duplicate hologram, a first laser light that satisfies a Bragg diffraction condition in the diffraction grating, a second light source that emits, to the master hologram and the duplicate hologram, a second laser light that does not satisfy the Bragg diffraction condition in the diffraction grating, and a sensor that measures the second laser light after passing through the master hologram and the duplicate hologram. The hologram manufacturing device ends exposure of the duplicate hologram with the first laser light based on a measurement result of the sensor.

To achieve the above-described object, a hologram manufacturing device according to another exemplary embodiment includes a master hologram on which a diffraction grating is formed, a duplicate hologram disposed close to the master hologram, a first light source that emits a first laser light for exposing the duplicate hologram to the duplicate hologram at a first incident angle, a second light source that emits a second laser light to the duplicate hologram at a second incident angle different from the first incident angle, and a sensor that measures the second laser light reflected by the duplicate hologram. The hologram manufacturing device ends exposure of the duplicate hologram with the first laser light based on a measurement result of the sensor.

The present disclosure can improve the accuracy of the duplicate hologram.

### BRIEF DESCRIPTION OF THE DRAWINGS

FIG. 1 is a schematic diagram of a hologram manufacturing device according to a first exemplary embodiment.

FIG. 2 is a diagram for describing a configuration of a hologram recording body according to the first exemplary embodiment.

FIG. 3 is a sectional view illustrating a state during exposure of the hologram recording body according to the first exemplary embodiment.

FIG. 4 is a diagram for describing spot light formed on a light receiving surface of a light receiving sensor according to the first exemplary embodiment.

FIG. 5 is a schematic diagram of a hologram manufacturing device according to a second exemplary embodiment.

FIG. 6 is a schematic diagram of a hologram manufacturing device according to a third exemplary embodiment.

FIG. 7 is a graph showing a relationship between diffraction efficiency at the time of creating a duplicate hologram according to the third exemplary embodiment and a refractive index change amount An of the duplicate hologram.

FIG. 8 is a schematic diagram of a hologram manufacturing device according to a fourth exemplary embodiment.

FIG. 9 is a sectional view of a duplicate hologram at the time of creating a duplicate hologram according to the fourth exemplary embodiment.

FIG. 10 is a graph showing a relationship between diffraction efficiency at the time of creating a duplicate hologram according to the fourth exemplary embodiment and a refractive index change amount Δn of the duplicate hologram.

FIG. 11 is a side view of a hologram manufacturing device according to a fifth exemplary embodiment.

FIG. 12 is a top view of the hologram manufacturing device according to the fifth exemplary embodiment.

FIG. 13 is a sectional view illustrating a state during exposure of a hologram recording body according to the fifth exemplary embodiment.

FIG. 14 is a perspective view illustrating an incident angle of laser light L2 on a duplicate hologram according to the fifth exemplary embodiment.

FIG. 15 is a sectional view illustrating a state during exposure of the duplicate hologram according to the fifth exemplary embodiment.

FIG. 16 is a plan view illustrating a state during exposure of the duplicate hologram according to the fifth exemplary embodiment.

FIG. 17 is a side view of a hologram manufacturing device according to a sixth exemplary embodiment.

FIG. 18 is a top view of the hologram manufacturing device according to the sixth exemplary embodiment.

FIG. 19 is a perspective view of the hologram manufacturing device according to the sixth exemplary embodiment.

### DESCRIPTION OF EMBODIMENT

Hereinafter, exemplary embodiments of the present invention will be described in detail with reference to the drawings. The following description of preferred exemplary embodiments is merely exemplary in nature and is not intended to limit the present invention, its applications, or its uses. In the following description, the same portions are denoted by the same reference numerals, and detailed description thereof will be omitted as appropriate.

### First Exemplary Embodiment

### Overall Configuration of Hologram Manufacturing Device

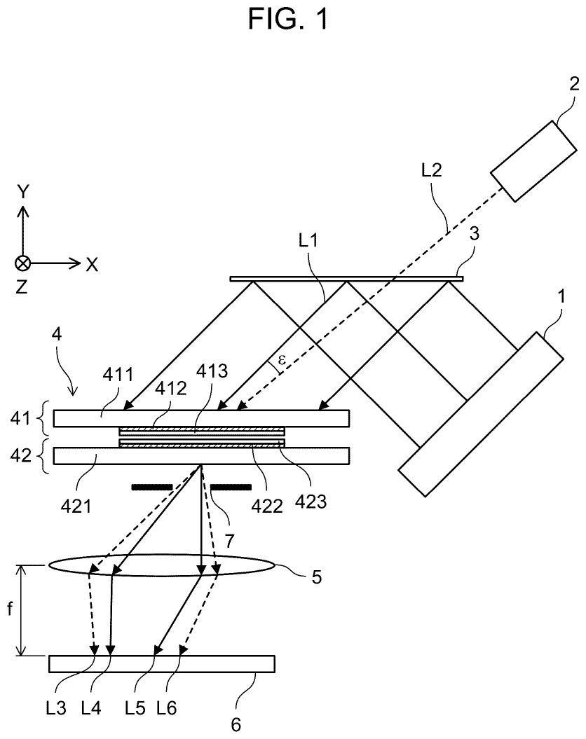

FIG. 1 is a schematic diagram of a hologram manufacturing device according to a first exemplary embodiment. In FIG. 1, the width directions of hologram recording body 4 are defined as an X direction and a Z direction, and a thickness direction of hologram recording body 4 is defined as a Y direction.

As illustrated in FIG. 1, the hologram manufacturing device according to the first exemplary embodiment includes light sources 1, 2, half mirror 3, hologram recording body 4, condenser lens 5, and light receiving sensor 6.

Light source 1 (first light source) is a light source that emits laser light, and emits laser light L1 (exposure light). Laser light L1 is laser light having a long coherence length, and is parallel light having a uniform intensity distribution with sufficiently high spatial coherence and small wavefront aberration. An area including at least an effective area of photopolymer 412, 422 described later is irradiated with laser light L1. The coherence length of laser light L1 is desirably longer than or equal to the total length of master hologram 41 and duplicate hologram 42 described later. Light source 1 may be configured by a light emitting diode (LED) or the like.

Light source 2 (second light source) is a light source that emits laser light, and emits laser light L2 (reference light). Like laser light L1, laser light L2 is laser light having a long coherence length, and is parallel light having a uniform intensity distribution with sufficiently high spatial coherence and small wavefront aberration. Substantially the center of the effective area of master hologram 41 and duplicate hologram 42 are irradiated with laser light L2. Light source 2 may be configured by a light emitting diode (LED) or the like. Light sources 1, 2 may be the same light source, and laser light L2 may be light separated from laser light L1.

Half mirror 3 reflects laser light L1 emitted from light source 1 and causes laser light L1 to enter hologram recording body 4. Half mirror 3 transmits laser light L2 emitted from light source 2 and causes laser light L2 to enter hologram recording body 4. Half mirror 3 has a sufficiently high reflectance, for example, a reflectance of more than or equal to 95%. As illustrated in FIG. 1, half mirror 3 causes laser light L1 to enter hologram recording body 4 in such a manner as to form an angle ε with respect to laser light L2. That is, laser lights L1, L2 are multiplexed by half mirror 3.

Condenser lens 5 is a lens that condenses laser lights L3 to L6 transmitted through hologram recording body 4. Opening 7 for measurement is formed below hologram recording body 4 in the drawing, and condenser lens 5 condenses emitted laser lights L3 to L6 via opening 7. The focal length of condenser lens 5 is f.

Light receiving sensor 6 (first sensor) is a light receiving sensor having a two-dimensional pixel structure. For example, light receiving sensor 6 is a CCD camera, a CMOS camera, or the like. Light receiving sensor 6 is disposed at a position of a distance f from condenser lens 5. That is, light receiving sensor 6 is disposed on the emission side focal plane of condenser lens 5.

### Configuration of Hologram Recording Body

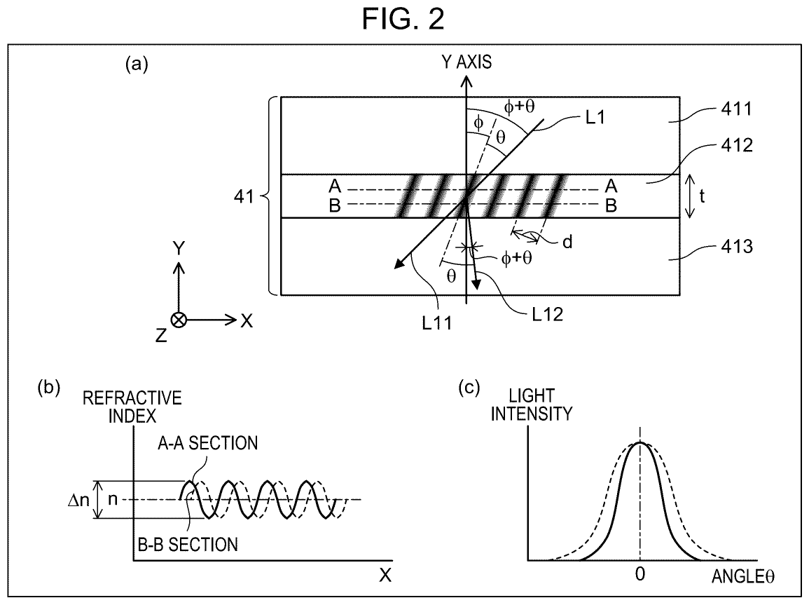

FIG. 2(a) is a sectional view illustrating a configuration of a hologram recording body according to the first exemplary embodiment.

As illustrated in FIGS. 1 and 2(a), hologram recording body 4 includes master hologram 41 and duplicate hologram 42. In the present exemplary embodiment, by irradiating master hologram 41 with laser light L1, the same diffraction grating as diffraction grating g1 formed in master hologram 41 is formed in duplicate hologram 42.

As illustrated in FIGS. 1 and 2(a), master hologram 41 includes transparent substrate 411, photopolymer 412, and protective film 413. Transparent substrate 411, photopolymer 412, and protective film 413 are stacked.

Transparent substrate 411 is a flat plate having high transmittance, and for example, quartz, optical glass, or the like is used. An antireflection film is formed on the upper surface of transparent substrate 411 in the drawing.

Photopolymer 412 is formed of, for example, an optical material whose refractive index changes when receiving visible light. The refractive index change amount of photopolymer 412 is determined by the amount of energy received by photopolymer 412, that is, the product of light intensity and time. Photopolymer 412 can stop a refractive index change through irradiation with ultraviolet rays. In photopolymer 412, a refractive index distribution (diffraction grating g1) is formed in advance using visible light having high and low light intensities, and thereafter, processing through ultraviolet irradiation is performed so that the refractive index distribution does not change. As a result, predetermined interference fringes are formed in photopolymer 412. The refractive index of photopolymer 412 is about 1.5 to 1.6, and the refractive index change amount by visible light is about 0.01 to 0.1. Thickness t of photopolymer 412 is formed between 1 μm and 100 μm. The larger thickness t of photopolymer 412, the higher the diffraction efficiency in photopolymer 412 can be. In this case, the characteristic of the first-order diffracted light with respect to the incident angle on photopolymer 412 also becomes sensitive, and the first-order diffracted light is greatly attenuated with a small change in the incident angle.

Protective film 413 is a thin transparent protective layer for protecting photopolymer 412, and is formed of, for example, a material that is not easily scratched, such as thin glass having high transmittance. An antireflection film is formed on the upper surface of protective film 413 in the drawing. The thickness of protective film 413 is at least smaller than the thickness of transparent substrate 411. The average refractive index of transparent substrate 411 and photopolymer 412 and the refractive index of protective film 413 are desirably close to each other.

Duplicate hologram 42 includes transparent substrate 421, photopolymer 422, and protective film 423. Transparent substrate 421, photopolymer 422, and protective film 423 are stacked.

Transparent substrate 421, photopolymer 422, and protective film 423 have the same configurations as those of transparent substrate 411, photopolymer 412, and protective film 413, respectively. However, photopolymer 422 has the same thickness t as photopolymer 412, and in the initial state, no refractive index distribution is formed and no ultraviolet irradiation is performed.

As illustrated in FIG. 1, duplicate hologram 42 is disposed close to master hologram so as to be parallel to each other in a state of being rotated by 180° with respect to master hologram 41.

As described above, photopolymer 412 is formed with a refractive index distribution (diffraction grating g1). The refractive index distribution of photopolymer 412 has a distribution in the XY section and is uniform in the Z-axis direction. That is, photopolymer 412 has the same refractive index distribution in the XY section at any Z-axis position. In the refractive index distribution in photopolymer 412, a portion having a high refractive index and a portion having a low refractive index are periodically formed. In photopolymer 412, a Bragg diffraction grating which is a diffraction grating based on a so-called thick refractive index distribution is formed. The diffraction grating is formed at a pitch d and at an angle φ with respect to the Y axis in the XY plane. Thus, in the X-axis direction, the pitch of the diffraction grating is d/cos (φ).

FIG. 2(b) is a graph showing refractive indexes of section A-A and section B-B of photopolymer 412 of FIG. 2(a). As illustrated in FIG. 2(b), the refractive indexes of section A-A and section B-B change in a sinusoidal shape. The average refractive index is n, and the refractive index change amount is Δn. The difference in refractive index change between section A-A and section B-B is only that the waveform is laterally shifted. When laser light having high coherence enters master hologram 41 having such a periodic refractive index distribution, light diffraction called Bragg diffraction occurs. As a feature of Bragg diffraction, strong diffracted light in a specific direction, that is, first-order diffracted light is generated. Most of the emitted light due to Bragg diffraction is 0th-order diffraction and first-order light, and high-order diffracted light is hardly generated.

The Bragg diffraction condition in photopolymer 412 is 2×n×d×sin(θ)=λ when the average refractive index of photopolymer 412 is n, the pitch of the diffraction grating is d, the incident angle on the diffraction grating is θ, and the wavelength of the incident light is λ. As for the light beam direction, an angle change based on Snell's law occurs due to refraction in photopolymer 412. That is, when the orientation with respect to the Y axis in the air is α, since the refractive index of photopolymer 412 is n, orientation β in photopolymer 412 is sin(α)=n×sin(β).

When the Bragg diffraction condition is satisfied in photopolymer 412, the phases of light when light entering the diffraction grating is reflected by the respective diffraction gratings are aligned, and thus strong diffracted light is generated in the −θ direction with respect to the diffraction grating. That is, when light beam L11 forming an angle of φ+θ with respect to the Y axis enters photopolymer 412, light beam L12 forming an angle of φ−θ with respect to the Y axis is emitted as the first-order diffracted light, and light beam L13 forming an angle of φ+θ with respect to the Y axis is emitted (transmitted) as the 0th-order diffracted light (light that is not diffracted). The angle formed by light beam L12 and light beam L13 is 2θ.

For the incident light out of the Bragg diffraction condition in light beam L11, the reflection phase of the light from each layer of the diffraction grating is shifted, the light intensity of the first-order diffracted light (light beam L12) decreases, and the light intensity (transmitted light) of the 0th-order diffracted light (light beam L13) increases.

FIG. 2(c) illustrates the light intensity of the first-order diffracted light (light beam L11) in the incident light (light beam L12) with respect to photopolymer 412. The light intensity of the first-order diffracted light is maximized at incident angle θ satisfying the Bragg diffraction condition, and the light intensity of the first-order diffracted light decreases as it shifts from θ. When the light intensity of the first-order diffracted light decreases, the light intensity of the 0th-order diffracted light increases. The intensity characteristic of the first-order diffracted light varies depending on the wavelength of the incident light (light beam L12), the refractive index of photopolymer 412, and the thickness of photopolymer 412.

In FIG. 2(c), the light intensity of the first-order diffracted light when the thickness of photopolymer 412 is t is indicated by a broken line, and the light intensity of the first-order diffracted light when the thickness of photopolymer 412 is 2×t is indicated by a solid line. As illustrated in FIG. 2(c), the thicker photopolymer 412, the more sensitive the angle characteristic of the first-order diffracted light with respect to the incident angle on the Bragg diffraction grating, and the larger the decrease in the first-order diffracted light due to the shift from the incident angle at which Bragg diffraction occurs.

### Operation of Hologram Manufacturing Device

Next, the operation of the hologram manufacturing device when creating duplicate hologram 42 will be described.

As illustrated in FIG. 1, laser light L1 that is a parallel light beam is reflected by half mirror 3 and enters master hologram 41. Laser light L1 that has entered master hologram 41 is refracted by transparent substrate 411 based on Snell's law to change the light beam orientation. At this time, since transparent substrate 411, photopolymer 412, and protective film 413 have substantially the same refractive index, the light beam orientations in transparent substrate 411, photopolymer 412, and protective film 413 are substantially the same.

As illustrated in FIG. 2(a), the diffraction grating based on the refractive index distribution formed in photopolymer 412 is formed at an angle of φ with respect to the Y axis. Thus, laser light L1 enters photopolymer 412 at an angle of φ+θ with respect to the Y axis. That is, laser light L1 enters the diffraction grating at an angle of θ. When laser light L1 enters the diffraction grating at an angle of θ, first-order diffracted light (light beam L11) is generated in the −θ direction and 0th-order diffracted light (light beam L112) is generated in the θ direction with respect to the diffraction grating since the Bragg diffraction condition in photopolymer 412 is satisfied. That is, two light beams of light beams L11 and L12 are emitted from master hologram 41.

When the light emitted from master hologram 41 enters duplicate hologram 42, refraction according to Snell's law occurs again. Since duplicate hologram 42 has the same refractive index as the refractive index of master hologram 41, the light beam orientation in duplicate hologram 42 is the same as the light beam orientation in master hologram 41. That is, light beam L11 enters duplicate hologram 42 at an angle of φ+θ with respect to the Y axis, and light beam L12 enters duplicate hologram 42 at an angle of φ−θ with respect to the Y axis. The angle formed by light beam L11 and light beam L12 is 2θ, and the intermediate orientation between light beam L11 and light beam L12 is an angle of φ with respect to the Y axis. Since light beam L11 and light beam L12 are parallel light beams having high coherence and having an angle of 2θ formed with each other, interference fringes having high and low light intensities are generated. Since the condition that the intensities of the interference fringes intensify with each other is 2×n×d×sinθ=λ, the fringe pitch is pitch d in the orientation of φ+90 degrees with respect to the Y axis in the XY plane. In the orientation of φ with respect to the Y axis, since the optical path lengths of light beam L11 and light beam L12 coincide with each other, the light intensity distribution becomes uniform. In the same manner, the light intensity distribution does not change in the Z-axis direction. Thus, the interference fringes (diffraction grating) in photopolymer 422 of duplicate hologram 42, that is, the intensity distribution of the light intensity is the same as the shape of diffraction grating g1 based on the refractive index distribution of photopolymer 412 of master hologram 41. In photopolymer 422, since the refractive index changes depending on the light intensity, diffraction grating g1 having the same refractive index distribution as that of master hologram 41 can be formed in duplicate hologram 42 by stopping the light irradiation for duplicate hologram 42 when the ratio between the 0th-order diffracted light and the first-order diffracted light emitted from duplicate hologram 42 becomes the same as the ratio between the 0th-order diffracted light and the first-order diffracted light of master hologram 41. At this time, in duplicate hologram 42 created when there is an error in the exposure time, the direction of the first-order diffracted light with respect to the 0th-order diffracted light does not change, but an error occurs in the ratio between the 0th-order diffracted light and the first-order diffracted light. Here, in the duplication of duplicate hologram 42, since the orientations of the 0th-order diffracted light and the first-order diffracted light with master hologram 41 do not change, that is, the pitch of the diffraction grating formed in the duplicate hologram 42 does not change, the orientation of the first-order diffracted light does not change even though there is an error in the exposure time in duplicate hologram 42. What is affected by the error in the exposure time is the magnitude of the refractive index difference of the diffraction grating formed in photopolymer 422 of duplicate hologram 42. When the refractive index difference increases, the first-order diffracted light with respect to the 0th-order diffracted light increases, and conversely, when the refractive index difference decreases, the first-order diffracted light decreases.

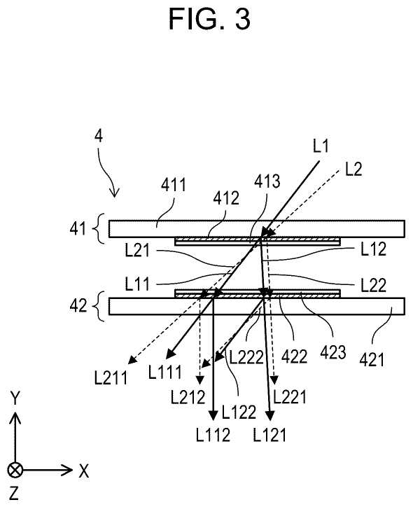

FIG. 3 is a sectional view illustrating a state during exposure of the hologram recording body according to the first exemplary embodiment.

As illustrated in FIG. 3, when laser light L1 enters master hologram 41, 0th-order diffracted light (light beam L11) and first-order diffracted light (light beam L12) are emitted from master hologram 41. Light beams L11, L12 generate a refractive index distribution in photopolymer 422 of duplicate hologram 42. When light beam L11 enters photopolymer 422, 0th-order diffracted light (light beam L111) and first-order diffracted light (light beam L112) are emitted from duplicate hologram 42 because of Bragg diffraction of duplicate hologram 42. When light beam L12 enters photopolymer 422, 0th-order diffracted light (light beam L121) and first-order diffracted light (light beam L122) are emitted from duplicate hologram 42 because of Bragg diffraction of duplicate hologram 42. As the exposure of duplicate hologram 42 progresses, the light intensity of light beam L11 which is transmitted light of light beam L111 decreases, and the light intensity of light beam L112 which is first-order diffracted light increases. In the same manner, the light intensity of light beam L12 which is transmitted light of light beam L122 decreases, and the light intensity of light beam L121 which is first-order diffracted light increases. At this time, light beams L111, L122 have the same light beam orientation, and light beams L112, L121 have the same light beam orientation.

As illustrated in FIG. 3, laser light L2 undergoes Bragg diffraction at master hologram 41 and duplicate hologram 42, and four pieces of diffracted light are generated in the same manner as the exposure light. The light beam orientations of light beams L211, L222 are the same, and the light beam orientations of light beams L212, L221 are the same.

When the amount of diffracted light of laser light L2 is calculated in the same manner as laser light L1, the light amount ratio between the 0th-order diffracted light and the first-order diffracted light during exposure of duplicate hologram 42 is (1−b):b assuming that the light intensity of the 0th-order diffracted light (light beam L21) of master hologram 41 is 0.5+c and the light intensity of the first-order diffracted light (light beam L22) is 0.5−c. c is a decrease in light amount caused by the shift of the Bragg diffraction grating formed on master hologram 41 and duplicate hologram 42 from the Bragg diffraction condition in laser light L2. c is 0 in the Bragg diffraction condition, and increases as the shift from the incident angle of the Bragg diffraction condition increases. That is, as the shift of the Bragg diffraction condition from the incident angle increases, the first-order diffracted light decreases and the 0th-order diffracted light increases. b is first-order diffracted light generated by forming a Bragg diffraction grating in photopolymer 422 through exposure in duplicate hologram 42. b is 0 at the exposure start time point, and increases as the exposure progresses.

The light intensity of light beam L211 emitted from duplicate hologram 42 is (0.5+c)×(1−b), and the light intensity of light beam L222 is (0.5−c)×b. When light beams L211, L222 are added, the light intensity becomes Q=0.5+c−2×c×b. Thus, c≠0 holds when laser light L2 is caused to enter at an angle shifted from the incident angle satisfying the Bragg diffraction condition of master hologram 41 and duplicate hologram 42. For this reason, as the exposure of duplicate hologram 42 proceeds, b increases, and thus light intensity Q changes. That is, the progress of exposure of duplicate hologram 42 can be measured. Thus, during the exposure of duplicate hologram 42, the light amount ratio between the first-order diffracted light and the 0th-order diffracted light caused by the refractive index difference of photopolymer 422 of duplicate hologram 42 can be accurately measured. Since the same applies to light beams L212, L221, the progress of duplicate hologram 42 may be measured using light beams L212, L221.

As illustrated in FIG. 1, the light emitted from duplicate hologram 42 is transmitted through opening 7 and condensed by condenser lens 5. Laser light L3 corresponds to light beams L211, L222, laser light L4 corresponds to light beams L111, L122, laser light L5 corresponds to light beams L112, L121, and laser light L6 corresponds to light beams L212, L221.

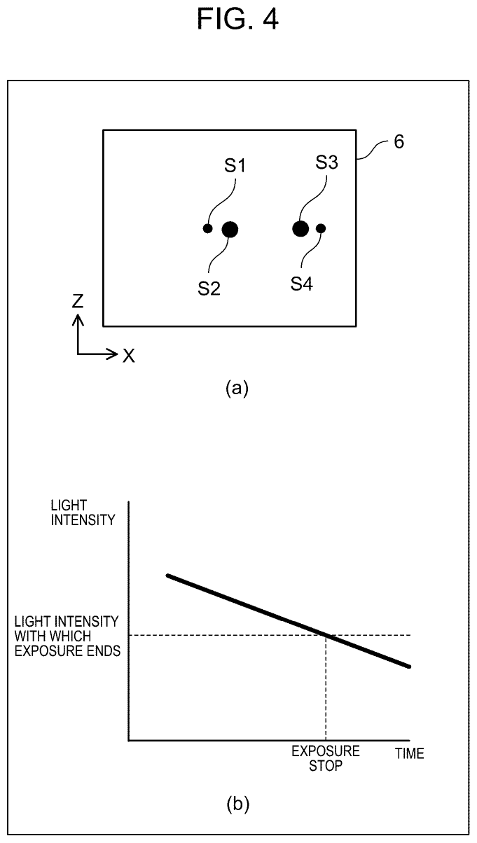

Light receiving sensor 6 is disposed on the focal plane of condenser lens 5. Since the emission light of duplicate hologram 42 is parallel light, four spots are formed on the light receiving surface of light receiving sensor 6 (see FIG. 4(a)). Spot lights S1 to S4 are spot lights generated by laser lights L3 to L6.

FIG. 4(b) is a graph showing light intensity of spot light S1. As illustrated in FIG. 4(b), the light intensity of spot light S1 decreases as the exposure progresses. Duplicate hologram 42 according to the design value is obtained by ending the application of laser light L1 when the light amount of spot light S1 reaches a predetermined light amount. The light amount of spot light S1 with which the exposure ends may be obtained in advance by an experiment. The exposure may be ended using spot light S4 instead of spot light S1.

After the exposure of duplicate hologram 42 with laser light L1 is ended, master hologram 41 is removed from hologram recording body 4, and duplicate hologram 42 is irradiated with ultraviolet light so that the exposure with visible light does not proceed in photopolymer 422.

With the above-described configuration, the hologram manufacturing device according to the first exemplary embodiment includes master hologram 41 on which diffraction grating g1 is formed, duplicate hologram 42 disposed close to master hologram 41, light source 1 (first light source) that emits, to master hologram 41 and duplicate hologram 42, laser light L1 (first laser light) that satisfies a Bragg diffraction condition in diffraction grating g1, light source 2 (second light source) that emits, to master hologram 41 and duplicate hologram 42, laser light L2 (second laser light) that does not satisfy the Bragg diffraction condition in diffraction grating g1, and light receiving sensor 6 that measures laser lights L3, L6 (laser light L2 after passing through master hologram 41 and duplicate hologram 42), wherein exposure of duplicate hologram 42 ends based on a measurement result of light receiving sensor 6.

According to this configuration, since laser light L2 enters master hologram 41 and duplicate hologram 42 so as not to satisfy the Bragg condition of the diffraction grating formed on master hologram 41, the light intensity of laser lights L3, L6 corresponding to laser light L2 having passed through master hologram 41 and duplicate hologram 42 changes according to the exposure time of duplicate hologram 42. This makes it possible to measure the progress of exposure of duplicate hologram 42, and the accuracy of the duplicate hologram can be improved.

In the first exemplary embodiment, light source 2 emits laser light L2 such that the vicinity of the center of laser light L1 (the vicinity of the center of master hologram 41) is irradiated with laser light L2.

In addition, by reducing the irradiation area of laser light L2, it is possible to measure thickness t of the photopolymer locally, and it is possible to create a duplicate hologram with higher accuracy.

The progress of exposure of duplicate hologram 42 may be managed by irradiating the unused area of duplicate hologram 42 with laser light L2.

To manage the progress of exposure of duplicate hologram 42, the Bragg diffraction condition in photopolymer 412 of master hologram 41 is used, but a condition in transmission diffraction with the surface shape of photopolymer 412 may be used. However, in the transmission diffraction with the surface shape, high order diffracted light is likely to be emitted, which easily leads to an error of the duplicate hologram.

Although the refractive index distribution of master hologram 41 is made uniform in the Z-axis direction, the refractive index distribution of the master hologram may be formed by piecing distributions obtained by partially rotating the distribution around the Y-axis together.

### Second Exemplary Embodiment

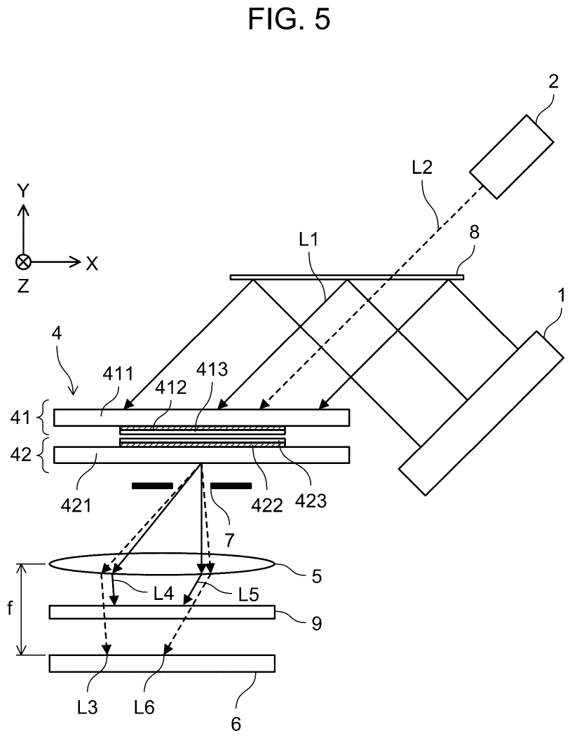

FIG. 5 is a schematic diagram of a hologram manufacturing device according to a second exemplary embodiment. In the first exemplary embodiment, the progress of exposure of duplicate hologram 42 is measured by shifting the incident angles (angles ε) of laser lights L1, L2 with respect to master hologram 41. In the second exemplary embodiment, the progress of exposure of duplicate hologram 42 is measured by shifting the wavelengths of laser lights L1, L2.

Specifically, laser lights L1, L2 are laser lights having different wavelengths.

Wavelength filter 8 (first wavelength filter) is a wavelength filter that reflects laser light L1 and transmits laser light L2. Wavelength filter 8 is formed of a dielectric multilayer film or the like, and has an action of reflecting light with a reflectance of approximately 100% in a specific wavelength band and transmitting light with a transmittance of approximately 100% in another wavelength band due to interference of light in the multilayer film. Since the wavelength of laser light L2 is different from the wavelength of laser light L1, wavelength filter 8 reflects laser light L1 with high reflectance and transmits laser light L2 with high transmittance.

Wavelength filter 9 (second wavelength filter) is a wavelength filter that is disposed between condenser lens 5 and light receiving sensor 6 and transmits laser light L2 of the light transmitted through duplicate hologram 205, and absorbs or reflects laser light L1.

### Operation of Hologram Manufacturing Device

Next, the operation of the hologram manufacturing device will be described. The exposure between master hologram 41 and duplicate hologram 42 is the same as that in the first exemplary embodiment. Specifically, laser light L1 is reflected by wavelength filter 8 and applied to master hologram 41. Exposure is performed by generating interference fringes in the duplicate hologram with 0th-order diffracted light and first-order diffracted light with Bragg diffraction in master hologram 41 to form a refractive index distribution.

In the second exemplary embodiment, the light beam orientations of laser lights L1, L2 are the same, but the wavelengths of laser lights L1, L2 are different. As a result, laser light L2 does not satisfy the Bragg diffraction condition. Specifically, since the Bragg diffraction condition is expressed as 2×n×d×sin(θ)=λ, changing incident angle λ is equivalent to changing wavelength λ.

Here, laser lights L3, L4 emitted from duplicate hologram 42 are parallel. Thus, laser lights L3, L4 overlap. Since wavelength filter 9 transmits laser light L3 (corresponding to laser light L2) and reflects laser light L4 (corresponding to laser light L1), only laser light L3 is emitted from wavelength filter 9. This makes it possible to measure the progress of exposure of duplicate hologram 42.

### Third Exemplary Embodiment

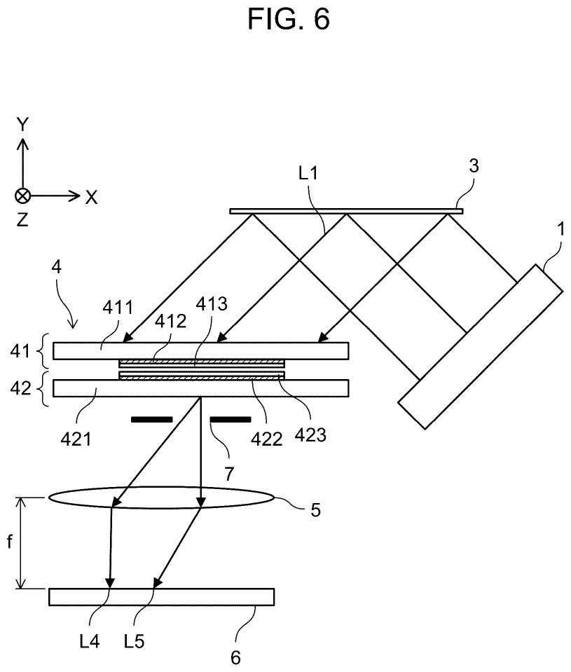

FIG. 6 is a schematic diagram of a hologram manufacturing device according to a third exemplary embodiment. In the first exemplary embodiment, the progress of exposure of duplicate hologram 42 is measured using laser lights L1, L2. In the third exemplary embodiment, the progress of exposure of duplicate hologram 42 is measured using only laser light L1 (exposure light) without using laser light L2 (reference light). Specifically, in FIG. 6, light source 2 in FIG. 1 is omitted. Thus, light receiving sensor 6 (here, the sensor corresponds to the second sensor) measures laser lights L4, L5.

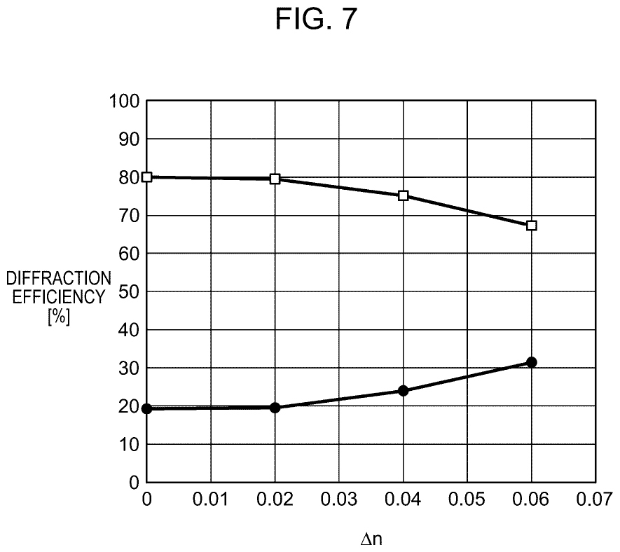

FIG. 7 is a graph showing a relationship between diffraction efficiency at the time of creating the duplicate hologram according to the third exemplary embodiment and refractive index change amount Δn of the duplicate hologram. Specifically, FIG. 7 is a graph when the ratio of laser lights L4, L5 emitted from master hologram 41 and duplicate hologram 42 at the time of exposure disclosure is 4:1. In FIG. 7, the variation of laser light L4 is plotted by white squares, and the variation of laser light L5 is plotted by black squares.

As illustrated in FIG. 7, as the exposure of duplicate hologram 42 progresses (as refractive index change amount Δn increases), the diffraction efficiency of laser lights L4, L5 changes. That is, the progress of exposure of duplicate hologram 42 can be measured by measuring only laser light L4 which is 0th-order diffracted light and laser light L5 which is first-order diffracted light (that is, only laser light L1) when laser light L1 is transmitted through master hologram 41 and duplicate hologram 42.

### Fourth Exemplary Embodiment

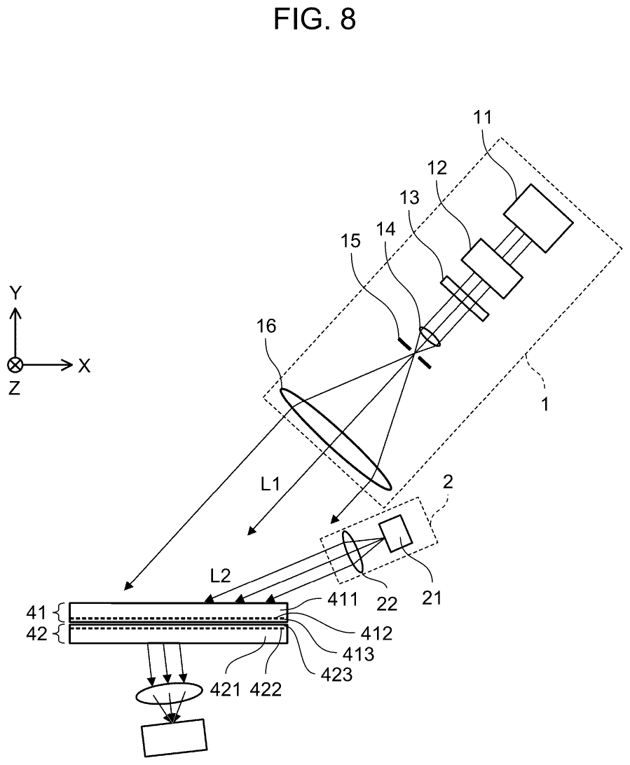

FIG. 8 is a schematic diagram of a hologram manufacturing device according to a fourth exemplary embodiment. In the first exemplary embodiment, the progress of exposure of duplicate hologram 42 is measured by shifting the incident angles (angles ε) of laser lights L1, L2 with respect to master hologram 41. In the second exemplary embodiment, the progress of exposure of duplicate hologram 42 is measured by causing laser lights L1, L2 to enter master hologram 41 and duplicate hologram 42 at different angles in the XZ plane.

As illustrated in FIG. 8, light source 1 includes laser light source 11, optical isolator 12, λ/2 wavelength plate 13, condenser lens 14, pinhole 15, and collimator lens 16.

Laser light source 11 is a light source that emits laser light L1. Laser light source 11 emits laser light L1 having high coherence, the light being parallel light and monochromatic linearly polarized light.

Optical isolator 12 suppresses return light from λ/2 wave plate 13 side to laser light source 11.

λ/2 wave plate 13 controls the polarization direction of incident laser light L1. This controls laser light L1 in a polarization direction optimum for exposure.

Condenser lens 14 condenses laser light L1 that has entered through λ/2 wavelength plate 13 to the diffraction limit.

Pinhole 15 is disposed at the focal position of condenser lens 14 and reduces optical noise included in laser light L1. For example, the optical noise included in laser light L1 can be removed by setting the diameter of pinhole 15 to be slightly larger than the diameter of the light intensity at which the spot light formed by condenser lens 14 becomes 1/e2.

Collimator lens 16 is disposed to have a focal position at pinhole 15, and it collimates the light (laser light L1) passing therethrough.

Light source 2 includes laser light source 21 and lens 22.

Laser light source 21 is a light source that emits laser light L2. Laser light source 21 emits laser light L2 which is near-infrared light having no sensitivity to photopolymer 422.

Lens 22 collimates incident laser light L2.

Here, although not illustrated, laser lights L1, L2 enter master hologram 41 and duplicate hologram 42 at different angles in plan view (when master hologram 41 and the duplicate hologram are viewed from above). For example, when laser light L1 enters master hologram 41 and duplicate hologram 42 along the Z direction, laser light L2 enters at an angle slightly shifted with respect to the Z direction. In this case, laser light L2 enters master hologram 41 and duplicate hologram 42 so as to satisfy the Bragg diffraction condition. Thus, when laser lights L1, L2 are transmitted through master hologram 41 and duplicate hologram 42, laser lights L1, L2 are transmitted in different directions. This allows light receiving sensor 6 to measure only laser light L7 which is transmitted light of laser light L2.

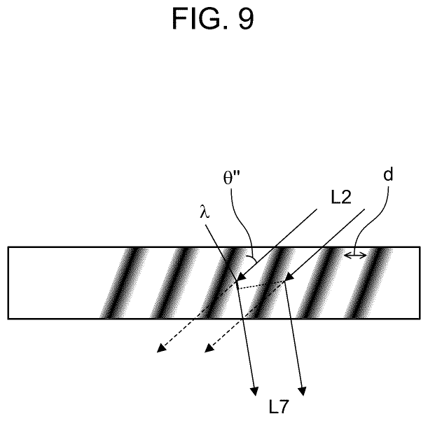

FIG. 9 is a sectional view of the duplicate hologram at the time of creating a duplicate hologram according to the fourth exemplary embodiment. For example, assuming that the interference fringe of duplicate hologram 42 with respect to laser light L2 is θ″, light beams (laser light L7) reflected by the interference fringe of duplicate hologram 42 interfere with each other and intensify each other in laser light L2 when λ=2×n×d×sinθ″ holds. When laser light L2 is caused to enter master hologram 41 and duplicate hologram 42 under this condition, laser light L2 (L7) can be measured by light receiving sensor 6.

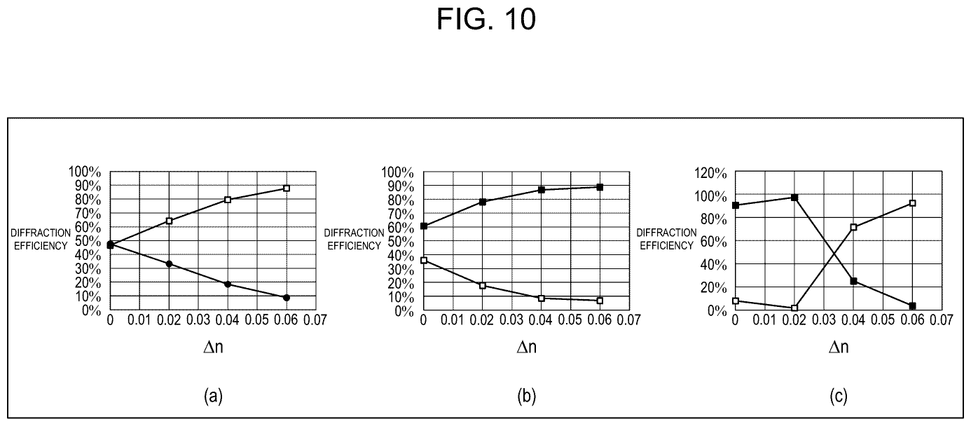

FIG. 10 is a graph showing a relationship between diffraction efficiency at the time of creating the duplicate hologram according to the fourth exemplary embodiment and refractive index change amount Δn of the duplicate hologram. Specifically, FIG. 10(a) is a graph in which the ratio between the 0th-order diffracted light and the first-order diffracted light of laser light L7 emitted from master hologram 41 and duplicate hologram 42 is 1:1 at the time of exposure disclosure, FIG. 10(b) is a graph in which the ratio between the 0th-order diffracted light and the first-order diffracted light of laser light L7 at the time of exposure disclosure is 1:2, and FIG. 10(c) is a graph in which the ratio between the 0th-order diffracted light and the first-order diffracted light of laser light L7 at the time of exposure disclosure is 1:9. In each drawing of FIG. 10, the variation of the 0th-order diffracted light of laser light L7 is plotted by white squares, and the variation of the first-order diffracted light of laser light L7 is plotted by black squares.

As illustrated in FIGS. 10(a) to 10(c), as the exposure of duplicate hologram 42 progresses (as refractive index change amount Δn increases), the diffraction efficiency of the 0th-order diffracted light and the first-order diffracted light of laser light L7 changes. That is, by measuring the 0th-order diffracted light and the first-order diffracted light of laser light L7, the progress of exposure of duplicate hologram 42 of duplicate hologram 42 can be measured.

### Fifth Exemplary Embodiment

### Overall Configuration of Hologram Manufacturing Device

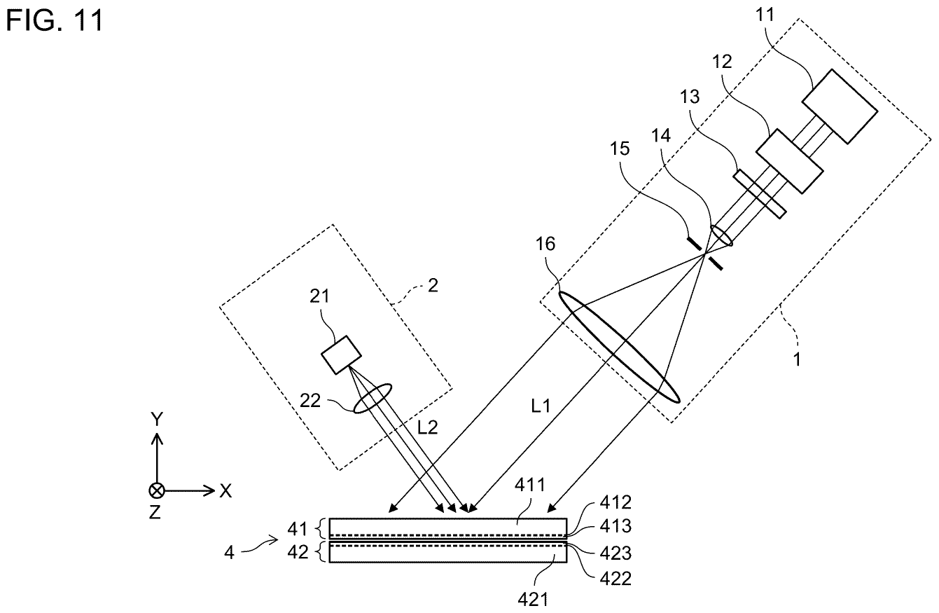

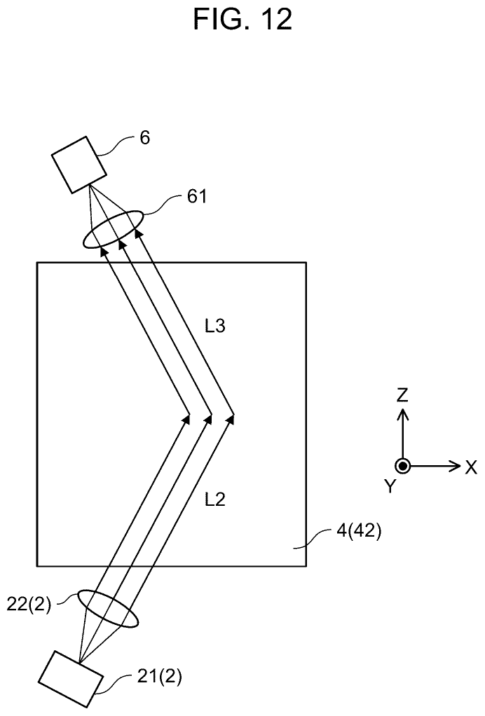

FIGS. 11 and 12 are schematic diagrams of a hologram manufacturing device according to a fifth exemplary embodiment. Specifically, FIG. 11 is a side view of the hologram manufacturing device according to the fifth exemplary embodiment, and FIG. 12 is a top view of the hologram manufacturing device according to the fifth exemplary embodiment. In FIG. 11, the width directions of hologram recording body 4 are defined as an X direction and a Z direction, and a thickness direction (up-down direction) of hologram recording body 4 is defined as a Y direction.

As illustrated in FIGS. 11 and 12, the hologram manufacturing device according to the fifth exemplary embodiment includes light sources 1, 2, hologram recording body 4, and light receiving sensor 6.

Light source 1 (first light source) is a light source that emits laser light, and it emits laser light L1 for exposing duplicate hologram 42 to be described later. Laser light L1 is laser light having a long coherence length, and is parallel light having a uniform intensity distribution with sufficiently high spatial coherence and small wavefront aberration. An area including at least an effective area of photopolymer 412, 422 described later is irradiated with laser light L1. The coherence length of laser light L1 is desirably longer than or equal to the total length of master hologram 41 and duplicate hologram 42 described later.

Specifically, light source 1 includes laser light source 11, optical isolator 12, λ/2 wavelength plate 13, condenser lens 14, pinhole 15, and collimator lens 16.

Laser light source 11 is a light source that emits laser light L1. Laser light source 11 emits laser light L1 having high coherence, the light being parallel light and monochromatic linearly polarized light. Laser light source 11 may be configured by a light emitting diode (LED) or the like.

Optical isolator 12 suppresses return light from λ/2 wave plate 13 side to laser light source 11.

λ/2 wave plate 13 controls the polarization direction of incident laser light L1. This controls laser light L1 in a polarization direction optimum for exposure.

Condenser lens 14 condenses laser light L1 that has entered through λ/2 wavelength plate 13 to the diffraction limit.

Pinhole 15 is disposed at the focal position of condenser lens 14 and reduces optical noise included in laser light L1. For example, the optical noise included in laser light L1 can be removed by setting the diameter of pinhole 15 to be slightly larger than the diameter of the light intensity at which the spot light formed by condenser lens 14 becomes 1/e².

Collimator lens 16 is disposed to have a focal position at pinhole 15, and it collimates the light (laser light L1) passing therethrough.

Light source 2 (second light source) is a light source that emits laser light, and it emits laser light L2 for managing exposure of duplicate hologram 42. Like laser light L1, laser light L2 is laser light having a long coherence length, and is parallel light having a uniform intensity distribution with sufficiently high spatial coherence and small wavefront aberration. Substantially the center of the effective area of master hologram 41 and duplicate hologram 42 are irradiated with laser light L2.

Specifically, light source 2 includes laser light source 21 and lens 22.

Laser light source 21 is a light source that emits laser light L2. Laser light source 21 emits laser light L2 which is near-infrared light having no sensitivity to photopolymer 422. Laser light source 21 may be configured by an LED or the like.

Lens 22 collimates incident laser light L2.

Light receiving sensor 6 is a light receiving sensor having a two-dimensional pixel structure. For example, light receiving sensor 6 is a CCD camera, a CMOS camera, or the like. As will be described in detail later, in FIG. 12, laser light L2 is emitted from the lower side of the drawing toward the upper side of the drawing. Then, laser light L2 is reflected by hologram recording body 4 (master hologram 41). This reflected laser light L2 is condensed by lens 61 and detected by light receiving sensor 6.

### Configuration of Hologram Recording Body

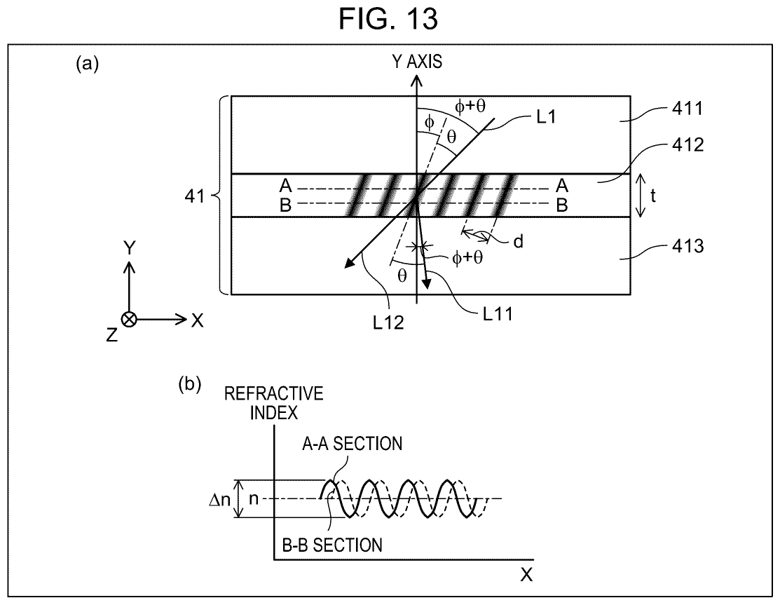

FIG. 13(a) is a sectional view illustrating a configuration of the hologram recording body according to the fifth exemplary embodiment.

As illustrated in FIGS. 11 and 13(a), hologram recording body 4 includes master hologram 41 and duplicate hologram 42. In the present exemplary embodiment, by irradiating master hologram 41 with laser light L1, the same diffraction grating as the diffraction grating formed in master hologram 41 is formed in duplicate hologram 42.

As illustrated in FIGS. 11 and 13(a), master hologram 41 includes transparent substrate 411, photopolymer 412, and protective film 413. Transparent substrate 411, photopolymer 412, and protective film 413 are stacked.

Transparent substrate 411 is a flat plate having high transmittance, and for example, quartz, optical glass, or the like is used. An antireflection film is formed on the upper surface of transparent substrate 411 in the drawing.

Photopolymer 412 is formed of, for example, an optical material whose refractive index changes when receiving visible light. The refractive index change amount of photopolymer 412 is determined by the amount of energy received by photopolymer 412, that is, the product of light intensity and time. Photopolymer 412 can stop a refractive index change through irradiation with ultraviolet rays. In photopolymer 412, a refractive index distribution (diffraction grating) is formed in advance using visible light having high and low light intensities, and thereafter, processing through ultraviolet irradiation is performed so that the refractive index distribution does not change. As a result, predetermined interference fringes are formed in photopolymer 412. The refractive index of photopolymer 412 is about 1.5 to 1.6, and the refractive index change amount by visible light is about 0.01 to 0.1. Thickness t of photopolymer 412 is formed between 1 μm and 100 μm. The larger thickness t of photopolymer 412, the higher the diffraction efficiency in photopolymer 412 can be. In this case, the characteristic of the first-order diffracted light with respect to the incident angle on photopolymer 412 also becomes sensitive, and the first-order diffracted light is greatly attenuated with a small change in the incident angle.

Protective film 413 is a thin transparent protective layer for protecting photopolymer 412, and is formed of, for example, a material that is not easily scratched, such as thin glass having high transmittance. An antireflection film is formed on the upper surface of protective film 413 in the drawing. The thickness of protective film 413 is at least smaller than the thickness of transparent substrate 411. The average refractive index of transparent substrate 411 and photopolymer 412 and the refractive index of protective film 413 are desirably close to each other.

Duplicate hologram 42 includes transparent substrate 421, photopolymer 422, and protective film 423. Transparent substrate 421, photopolymer 422, and protective film 423 are stacked.

Transparent substrate 421, photopolymer 422, and protective film 423 have the same configurations as those of transparent substrate 411, photopolymer 412, and protective film 413, respectively. However, photopolymer 422 has the same thickness t as photopolymer 412, and in the initial state, no refractive index distribution is formed and no ultraviolet irradiation is performed.

As illustrated in FIG. 11, duplicate hologram 42 is disposed close to master hologram 41 so as to be parallel to each other in a state of being rotated by 180° with respect to master hologram 41.

As described above, photopolymer 412 is formed with a refractive index distribution (diffraction grating). The refractive index distribution of photopolymer 412 has a distribution in the XY section and is uniform in the Z-axis direction. That is, photopolymer 412 has the same refractive index distribution in the XY section at any Z-axis position. In the refractive index distribution in photopolymer 412, a portion having a high refractive index and a portion having a low refractive index are periodically formed. In photopolymer 412, a Bragg diffraction grating which is a diffraction grating based on a so-called thick refractive index distribution is formed. The diffraction grating is formed at a pitch d and at an angle φ with respect to the Y axis in the XY plane. Thus, in the X-axis direction, the pitch of the diffraction grating is d/cos(φ).

FIG. 13(b) is a graph illustrating refractive indexes of section A-A and section B-B of photopolymer 412 of FIG. 13(a). As illustrated in FIG. 13(b), the refractive indexes of section A-A and section B-B change in a sinusoidal shape. The average refractive index is n, and the refractive index change amount is Δn. The difference in refractive index change between section A-A and section B-B is only that the waveform is laterally shifted. When laser light having high coherence enters master hologram 41 having such a periodic refractive index distribution, light diffraction called Bragg diffraction occurs. As a feature of Bragg diffraction, strong diffracted light in a specific direction, that is, first-order diffracted light is generated. Most of the emitted light due to Bragg diffraction is 0th-order diffraction and first-order light, and high-order diffracted light is hardly generated.

The Bragg diffraction condition in photopolymer 412 is 2×n×d×sin(θ)=λ when the average refractive index of photopolymer 412 is n, the pitch of the diffraction grating is d, the incident angle on the diffraction grating is θ, and the wavelength of the incident light is λ. As for the light beam direction, an angle change based on Snell's law occurs due to refraction in photopolymer 412. That is, when the orientation with respect to the Y axis in the air is α, since the refractive index of photopolymer 412 is n, orientation β in photopolymer 412 is sin(α)=n×sin(β).

When the Bragg diffraction condition is satisfied in photopolymer 412, the phases of light when light entering the diffraction grating is reflected by the respective diffraction gratings are aligned, and thus strong diffracted light is generated in the −θ direction with respect to the diffraction grating. That is, when laser light L1 having an angle of φ+θ with respect to the Y axis enters photopolymer 412, light beam L11 having an angle of φ−θ with respect to the Y axis is emitted as the first-order diffracted light, and light beam L12 having an angle of φ+θ with respect to the Y axis is emitted (transmitted) as the 0th-order diffracted light (light that is not diffracted). The angle formed by light beam L11 and light beam L12 is 2θ.

### Operation of Hologram Manufacturing Device

Next, the operation of the hologram manufacturing device when creating duplicate hologram 42 will be described.

As illustrated in FIG. 11, laser light L1 which is a parallel light beam is reflected by half mirror 3 and enters master hologram 41. Laser light L1 that has entered master hologram 41 is refracted by transparent substrate 411 based on Snell's law to change the light beam orientation. At this time, since transparent substrate 411, photopolymer 412, and protective film 413 have substantially the same refractive index, the light beam orientations in transparent substrate 411, photopolymer 412, and protective film 413 are substantially the same.

As illustrated in FIG. 13(a), the diffraction grating based on the refractive index distribution formed in photopolymer 412 is formed at an angle of φ with respect to the Y axis. Thus, laser light L1 enters photopolymer 412 at an angle of φ+θ with respect to the Y axis. That is, laser light L1 enters the diffraction grating at an angle of θ. When laser light L1 enters the diffraction grating at an angle of θ, first-order diffracted light (light beam L11) is generated in the −θ direction and 0th-order diffracted light (light beam L12) is generated in the θ direction with respect to the diffraction grating since the Bragg diffraction condition in photopolymer 412 is satisfied. That is, two light beams of light beams L11 and L12 are emitted from master hologram 41.

When the light emitted from master hologram 41 enters duplicate hologram 42, refraction according to Snell's law occurs again. Since duplicate hologram 42 has the same refractive index as the refractive index of master hologram 41, the light beam orientation in duplicate hologram 42 is the same as the light beam orientation in master hologram 41. That is, light beam L11 enters duplicate hologram 42 at an angle of φ+θ with respect to the Y axis, and light beam L12 enters duplicate hologram 42 at an angle of φ−θ with respect to the Y axis. The angle formed by light beam L11 and light beam L12 is 2θ, and the intermediate orientation between light beam L11 and light beam L12 is an angle of φ with respect to the Y axis. Since light beam L11 and light beam L12 are parallel light beams having high coherence and having an angle of 2θ formed with each other, interference fringes having high and low light intensities are generated. Since the condition that the intensities of the interference fringes intensify with each other is 2×n×d×sinθ=λ, the fringe pitch is pitch d in the orientation of φ+90 degrees with respect to the Y axis in the XY plane. In the orientation of φ with respect to the Y axis, since the optical path lengths of light beam L11 and light beam L12 coincide with each other, the light intensity distribution becomes uniform. In the same manner, the light intensity distribution does not change in the Z-axis direction. Thus, the interference fringes (diffraction grating) in photopolymer 422 of duplicate hologram 42, that is, the intensity distribution of the light intensity is the same as the shape of diffraction grating g1 based on the refractive index distribution of photopolymer 412 of master hologram 41. In photopolymer 422, since the refractive index changes depending on the light intensity, diffraction grating g1 having the same refractive index distribution as that of master hologram 41 can be formed in duplicate hologram 42 by stopping the light irradiation for duplicate hologram 42 when the ratio between the 0th-order diffracted light and the first-order diffracted light emitted from duplicate hologram 42 becomes the same as the ratio between the 0th-order diffracted light and the first-order diffracted light of master hologram 41. At this time, in duplicate hologram 42 created when there is an error in the exposure time, the direction of the first-order diffracted light with respect to the 0th-order diffracted light does not change, but an error occurs in the ratio between the 0th-order diffracted light and the first-order diffracted light. Here, in the duplication of duplicate hologram 42, since the orientations of the 0th-order diffracted light and the first-order diffracted light with master hologram 41 do not change, that is, the pitch of the diffraction grating formed in the duplicate hologram 42 does not change, the orientation of the first-order diffracted light does not change even though there is an error in the exposure time in duplicate hologram 42. What is affected by the error in the exposure time is the magnitude of the refractive index difference of the diffraction grating formed in photopolymer 422 of duplicate hologram 42. When the refractive index difference increases, the first-order diffracted light with respect to the 0th-order diffracted light increases, and conversely, when the refractive index difference decreases, the first-order diffracted light decreases.

The refractive index change amount of photopolymer 422 due to the exposure time is determined by the temperature and the photosensitivity for each production lot. In addition, the first-order diffracted light with respect to the 0th-order diffracted light changes depending on the thickness of photopolymer 422. That is, as the thickness increases, the amount of light to be transmitted through the grating having the refractive index distribution increases, and thus, the first-order diffracted light increases. For this reason, when the exposure amount is simply determined only by the time, the ratio between the 0th-order diffracted light and the first-order diffracted light by photopolymer 422 is different from the design value. Thus, it is conceivable to measure the first-order diffracted light of duplicate hologram 42, but it is difficult to measure the first-order diffracted light of duplicate hologram 42 during exposure because master hologram 41 and duplicate hologram 42 are disposed so as to overlap each other.

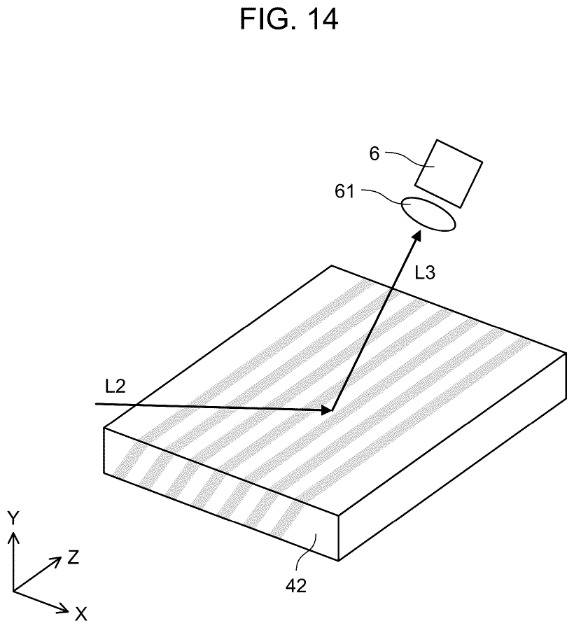

FIG. 14 is a perspective view illustrating the incident angle of laser light L2 on the duplicate hologram according to the fifth exemplary embodiment. Although not illustrated, laser lights L1, L2 enter master hologram 41 and duplicate hologram 42 at different angles in plan view (when master hologram 41 and the duplicate hologram are viewed from above). That is, in plan view, the incident angle (second incident angle) of laser light L2 is different from the incident angle (first incident angle) of laser light L1.

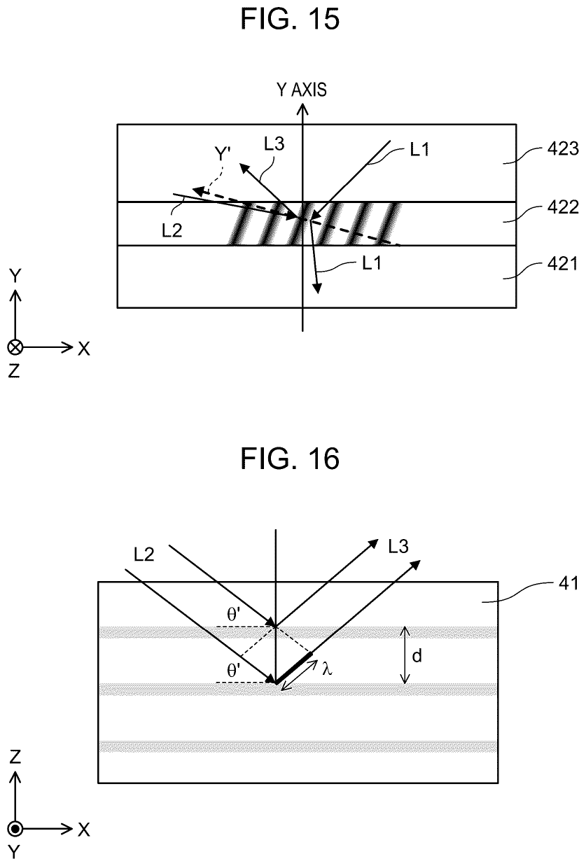

FIG. 15 is a sectional view illustrating a state during exposure of the duplicate hologram according to the fifth exemplary embodiment. As illustrated in FIG. 15, when the refractive index distribution (diffraction grating) of duplicate hologram 42 is irradiated with laser light L2 so as to satisfy the Bragg diffraction condition, laser light L3 (laser light L2 reflected by duplicate hologram 42) which is a part of laser light L2 is generated toward the upper left side of the drawing. Laser light L3 is generated symmetrically with respect to the normal direction (Y′ direction) with respect to the refractive index distribution of duplicate hologram 42.

FIG. 16 is a plan view illustrating a state during exposure of the duplicate hologram according to the fifth exemplary embodiment. As illustrated in FIG. 16, when the incident angle of laser light L2 with respect to the refractive index distribution is θ′, since laser light L2 has high coherence, the lights reflected by the refractive index distribution interfere with each other and intensify each other when 2×n×d×sinθ′=λ is satisfied. Laser light L3 is generated by causing laser light L2 to enter duplicate hologram 42 under the condition that this formula is satisfied. Light receiving sensor 6 is disposed to detect laser light L3.

Part of laser light L2 is reflected by master hologram 41 and duplicate hologram 42. Specifically, laser light L2 includes laser light L4 (not illustrated) reflected by the refractive index distribution of master hologram 41 and laser light L3 reflected by the refractive index distribution of duplicate hologram 42. Among them, since the refractive index distribution of master hologram 41 does not change, laser light L4 becomes constant. Then, the light amount of laser light L3 increases as the exposure of duplicate hologram 42 progresses. Thus, duplicate hologram 42 according to the design value is obtained by ending the application of laser light L2 when laser light L3 has reached the predetermined light amount. The light amount of laser light L3 with which the exposure ends may be obtained in advance by an experiment.

After the exposure of duplicate hologram 42 is ended, master hologram 41 is removed from hologram recording body 4, and duplicate hologram 42 is irradiated with ultraviolet light so that the exposure with visible light does not proceed in photopolymer 422.

With the above-described configuration, the hologram manufacturing device according to the fifth exemplary embodiment includes master hologram 41 on which a diffraction grating is formed, duplicate hologram 42 disposed close to master hologram 41, light source 1 (first light source) that emits laser light L1 (first laser light) for exposing duplicate hologram 42, light source L2 (second light source) that emits laser light L2 (second laser light) to duplicate hologram 42 at an incident angle different from an incident angle of laser light L1, and light receiving sensor 6 that measures laser light L3 (third laser light) that is laser light L2 reflected by duplicate hologram 42, wherein exposure of duplicate hologram 42 ends based on a measurement result of light receiving sensor 6.

According to this configuration, since laser lights L1, L2 are emitted at different incident angles with respect to duplicate hologram 42, only laser light L2 can be warped by the diffraction grating (refractive index distribution) of duplicate hologram 42, and only laser light L2 (laser light L3) can be measured by light receiving sensor 6. With this configuration, by measuring laser light L3, the progress of exposure of duplicate hologram 42 can be measured, and the accuracy of the duplicate hologram can be improved.

The wavelengths of laser lights L1 and L2 may be the same or different from each other.

Light source 2 is a laser light source that emits laser light L2 as parallel light. Alternatively, light source 2 may emit laser light L2 by collimating light emitted from laser light source 21 including an LED with lens 22.

Light source 2 emits laser light L2 such that the vicinity of the center of laser light L1 (the vicinity of the center of master hologram 41) is irradiated with laser light L2, but the irradiation position of laser light L2 is not limited to this configuration.

In the present exemplary embodiment, a case where there is one set of measurement optical systems including light source 2 and light receiving sensor 6 has been described as an example, but a plurality of measurement optical systems may be disposed, and the measurement of duplicate hologram 42 may be performed at a plurality of places.

### Sixth Exemplary Embodiment

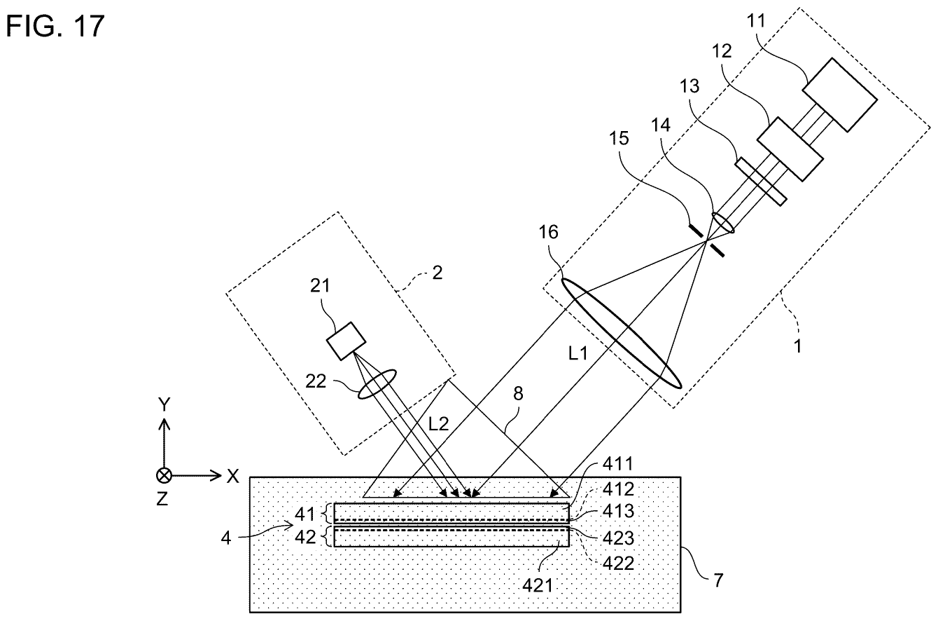

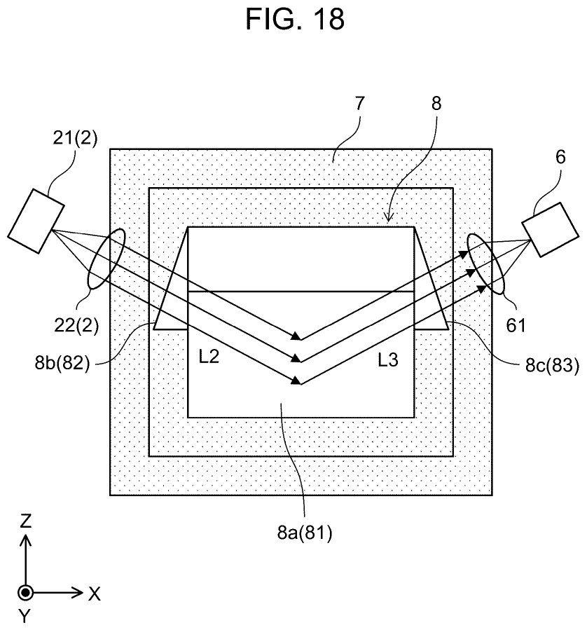

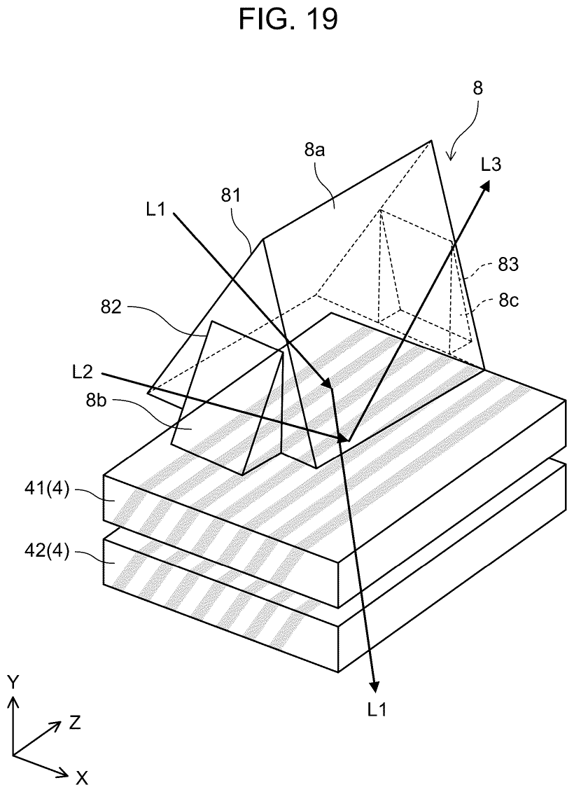

FIGS. 17 to 19 are schematic diagrams of a hologram manufacturing device according to a sixth exemplary embodiment. Specifically, FIG. 17 is a side view of the hologram manufacturing device according to the sixth exemplary embodiment, FIG. 18 is a top view of the hologram manufacturing device according to the sixth exemplary embodiment, and FIG. 19 is a perspective view of the hologram manufacturing device according to the sixth exemplary embodiment. In the fifth exemplary embodiment, duplicate hologram 42 is disposed in the air and exposed, but in the sixth exemplary embodiment, duplicate hologram 42 is immersed in liquid and exposed.

As illustrated in FIGS. 17 to 19, hologram recording body 4 (master hologram 41 and duplicate hologram 42) is disposed in water tank 7 filled with water. The inner wall of water tank 7 is formed of a material having a low light reflectance, and light reflection with the inner wall is reduced.

Coupling prism 8 is disposed above hologram recording body 4. Coupling prism 8 is made of a material having a refractive index substantially the same as that of water. Coupling prism 8 has a bottom surface disposed in water and side surfaces 81 to 83 disposed in the air. Side surfaces 82, 83 of coupling prism 8 are provided facing each other.

Here, laser light L1 passes through side surface 81 of coupling prism 8 and is applied to hologram recording body 4. As a result, even when laser light L1 is transmitted from coupling prism 8 to water, refraction of light according to Snell's law does not occur. Thus, laser light L1 can be applied to hologram recording body 4 without being refracted.

Laser light L2 is transmitted through side surface 82 of coupling prism 8, applied to hologram recording body 4, and emitted through side surface 83. In the same manner as laser light L1, laser light L2 can be applied to hologram recording body 4 without being refracted. Laser light L3 that is reflected light of laser light L2 can also be detected by light receiving sensor 6 so as not to be affected by refraction or total reflection.

As illustrated in FIG. 19, in coupling prism 8, prism 8a is disposed at the center having side surface 81, and prism 8b having side surface 82 and prism 8c having side surface 83 are formed at both ends in the X direction of prism 8a. With coupling prism 8 having such a shape, prisms corresponding to both exposure light and measurement light can be integrally formed. As a result, it is possible to improve the light use efficiency of the exposure light and the measurement light by improving the operability in the facility and improving the component accuracy.

In the sixth exemplary embodiment, as in the fifth exemplary embodiment, laser light L2 is emitted to satisfy the Bragg diffraction condition with respect to duplicate hologram 42. Light receiving sensor 6 measures the amount of reflected light (laser light L3) of laser light L2 at this time. Duplicate hologram 42 according to the design value is obtained by ending the application of laser light L2 when laser light L3 has reached the predetermined light amount. The light amount of laser light L3 with which the exposure ends is obtained in advance by an experiment. This makes it possible to improve the accuracy of the duplicate hologram.

Master hologram 41 and duplicate hologram 42 are immersed in liquid by being disposed in water tank 7 filled with water. Thus, refraction according to the Snell's side when laser light L1 enters transparent substrates 411, 421 can be suppressed. This makes it possible to increase the incident angle of laser light L1 with respect to master hologram 41 and duplicate hologram 42.

In addition, since light receiving sensor 6 is disposed outside water tank 7, the facility can be simplified.

Although water tank 7 is filled with water, liquid such as oil having the same refractive index as that of transparent substrates 411, 421 of master hologram 41 and duplicate hologram 42 may be filled. This makes it possible to eliminates the difference in refractive index between the liquid filled in water tank 7 and transparent substrates 411, 421, and interface reflection can be eliminated.

### INDUSTRIAL APPLICABILITY

The hologram manufacturing device of the present disclosure can be applied to a hologram optical element system such as a projector, a bed mounted display, or a head-up display.

### REFERENCE MARKS IN THE DRAWINGS

### First Exemplary Embodiment to Fourth Exemplary Embodiment

1, 2: light source (first light source, second light source)
3: half mirror
4: hologram recording body
41: master hologram
42: duplicate hologram
412, 422: photopolymer
5: condenser lens
6: light receiving sensor (first sensor, second sensor)
8, 9: wavelength filter (first wavelength filter, second wavelength filter)
L1, L2: laser light (first laser light, second laser light)

### Fifth Exemplary Embodiment to Sixth Exemplary Embodiment

1, 2: light source (first light source, second light source)
4: hologram recording body
41: master hologram
42: duplicate hologram
412, 422: photopolymer
6: light receiving sensor
7: water tank
8: coupling prism
L1 to L3: laser light (first to third laser light)

1. A hologram manufacturing device comprising:
a master hologram on which a diffraction grating is formed;
a duplicate hologram disposed close to the master hologram;
a first light source that emits, to the master hologram and the duplicate hologram, a first laser light that satisfies a Bragg diffraction condition in the diffraction grating;
a second light source that emits, to the master hologram and the duplicate hologram, a second laser light that does not satisfy the Bragg diffraction condition in the diffraction grating; and
a first sensor that measures the second laser light after passing through the master hologram and the duplicate hologram,
wherein exposure of the duplicate hologram with the first laser light ends based on a measurement result of the first sensor.

2. The hologram manufacturing device according to claim 1, wherein the first laser light and the second laser light are different from each other in an incident angle with respect to the master hologram.

3. The hologram manufacturing device according to claim 2, wherein the first laser light and the second laser light are different from each other in the incident angle in side view.

4. The hologram manufacturing device according to claim 2, wherein the first laser light and the second laser light are different from each other in the incident angle in plan view.

5. The hologram manufacturing device according to claim 3, the device further comprising a half mirror that multiplexes the first laser light and the second laser light.

6. The hologram manufacturing device according to claim 1, wherein the first laser light and the second laser light are different from each other in wavelength of light.

7. The hologram manufacturing device according to claim 6, the device further comprising a first wavelength filter that multiplexes the first laser light and the second laser light.

8. The hologram manufacturing device according to claim 7, the device further comprising a second wavelength filter disposed between the master hologram and the duplicate hologram, and the first sensor, the second wavelength filter not transmitting the first laser light.

9. A hologram manufacturing device comprising:
a master hologram on which a diffraction grating is formed;
a duplicate hologram disposed close to the master hologram;
a first light source that emits, to the master hologram and the duplicate hologram, a first laser light that satisfies a Bragg diffraction condition in the diffraction grating; and
a second sensor that measures the first laser light after passing through the master hologram and the duplicate hologram,
wherein exposure of the duplicate hologram with the first laser light ends based on a measurement result of the second sensor.

10. A hologram manufacturing method comprising:
a step of disposing a master hologram on which a diffraction grating is formed and a duplicate hologram close to each other;
a step of emitting, to the master hologram and the duplicate hologram, a first laser light that satisfies a Bragg diffraction condition in the diffraction grating and a second laser light that does not satisfy the Bragg diffraction condition in the diffraction grating; and
measuring the second laser light after passing through the master hologram and the duplicate hologram, and ending exposure of the duplicate hologram with the first laser light based on a result of the measurement.

11. A hologram manufacturing device comprising:
a master hologram on which a diffraction grating is formed;
a duplicate hologram disposed close to the master hologram;
a first light source that emits a first laser light for exposing the duplicate hologram to the duplicate hologram at a first incident angle;
a second light source that emits a second laser light to the duplicate hologram at a second incident angle different from the first incident angle; and
a sensor that measures the second laser light reflected by the duplicate hologram,
wherein exposure of the duplicate hologram with the first laser light ends based on a measurement result of the sensor.

12. The hologram manufacturing device according to claim 11, wherein the first laser light and the second laser light are different from each other in wavelength of light.

13. The hologram manufacturing device according to claim 11, wherein the second laser light is applied to the duplicate hologram and satisfies a Bragg diffraction condition of the diffraction grating formed on the master hologram.

14. The hologram manufacturing device according to claim 11, the device further comprising a water tank in which the master hologram and the duplicate hologram are immersed in liquid.

15. The hologram manufacturing device according to claim 14, the device further comprising a coupling prism disposed above the master hologram and the duplicate hologram.

16. The hologram manufacturing device according to claim 14, wherein the sensor is disposed outside the water tank.

17. A hologram manufacturing method comprising:
a step of disposing a master hologram on which a diffraction grating is formed and a duplicate hologram close to each other;
a step of emitting a first laser light for exposing the duplicate hologram to the duplicate hologram at a first incident angle and emitting a second laser light to the duplicate hologram at a second incident angle different from the first incident angle; and
a step of measuring the second laser light reflected by the duplicate hologram, and ending exposure of the duplicate hologram with the first laser light based on a result of the measurement.
